(19) United States
(12) Patent Application Publication
(10) Pub. No.: US 2014/0082406 A1
(43) Pub. Date: Mar. 20, 2014

(54) DATA PROTECTION THROUGH POWER LOSS PREDICTION

(71) Applicant: SANDISK TECHNOLOGIES INC., Plano, TX (US)

(72) Inventor: Eran Erez, San Jose, CA (US)

(73) Assignee: SANDISK TECHNOLOGIES INC., Plano, TX (US)

(21) Appl. No.: 13/622,235

(22) Filed: Sep. 18, 2012

(51) Int. Cl. G06F 11/07

(52) U.S. Cl. 714/2; 714/E11.023

(57) ABSTRACT

A memory system may enact emergency activities, such as preventing a write abort, by identifying when a power loss occurs at the earliest time possible. The prediction of a power loss during the process of programming a page, but before all power is lost may allow for the memory to initiate emergency activities. A power loss prediction mechanism may utilize a data link lost signal to trigger data protection. The data link lost signal may indicate that the data connection between the memory and a host has been lost. The signal indicating a data link loss may precede the actual detection of a power loss so that data protection can be implemented quicker.

### TECHNICAL FIELD

This application relates generally to memory devices. More specifically, this application relates to protecting data in non-volatile semiconductor flash memory when a power loss event occurs.

### BACKGROUND

Non-volatile memory systems, such as flash memory, have been widely adopted for use in consumer products. Flash memory may be found in different forms, for example in the form of a portable memory card that can be carried between host devices or as a solid state disk (SSD) embedded in a host device. During normal host operation, a write abort may occur and there is a risk of losing data that was programmed in a previous host command.

For example, binary (single-level cell “SLC”) and multi-level cell (MLC) NAND Flash Memory are forms of non-volatile memory (NVM) that are capable of high data storage densities and high performance, however, a power failure due to hot removal, brownout, blackout or the like may cause data corruption or loss due to the nature of the way in which data is written to this type of memory. Typically a “page” or group of bits at a time is written to the NVM. If a power failure occurs during a write cycle/program operation, not all of the bits of the page may be programmed successfully in the NVM. When the page containing unsuccessfully programmed bits is read back, some bits may have the new value, some will have the old value and, as a result, the page may be corrupted.

### SUMMARY

It may be desirable to identify when a power loss occurs at the earliest time possible. The prediction of a power loss before all power is lost may allow for the system/memory/NAND to initiate emergency activities, including preventing the loss of data from a write abort. A power loss prediction mechanism may utilize a data link lost signal to trigger the emergency activities. The data link lost signal may indicate that the data connection between the memory and a host has been lost. The signal indicating a data link loss may precede the actual detection of a power loss so that emergency activities, such as write abort protection, can be implemented earlier.

### BRIEF DESCRIPTION OF THE DRAWINGS

FIG. 1 is a block diagram of a host connected with a memory system having non-volatile memory.

FIG. 2 is a block diagram of an exemplary flash memory system controller for use in the system of FIG. 1.

FIG. 3 is a block diagram of an alternative memory communication system.

FIG. 4 is a diagram of a process for write abort prevention.

FIG. 5 is an illustration of write abort prevention.

FIG. 6 is a diagram of a connector.

### BRIEF DESCRIPTION OF THE PRESENTLY PREFERRED EMBODIMENTS

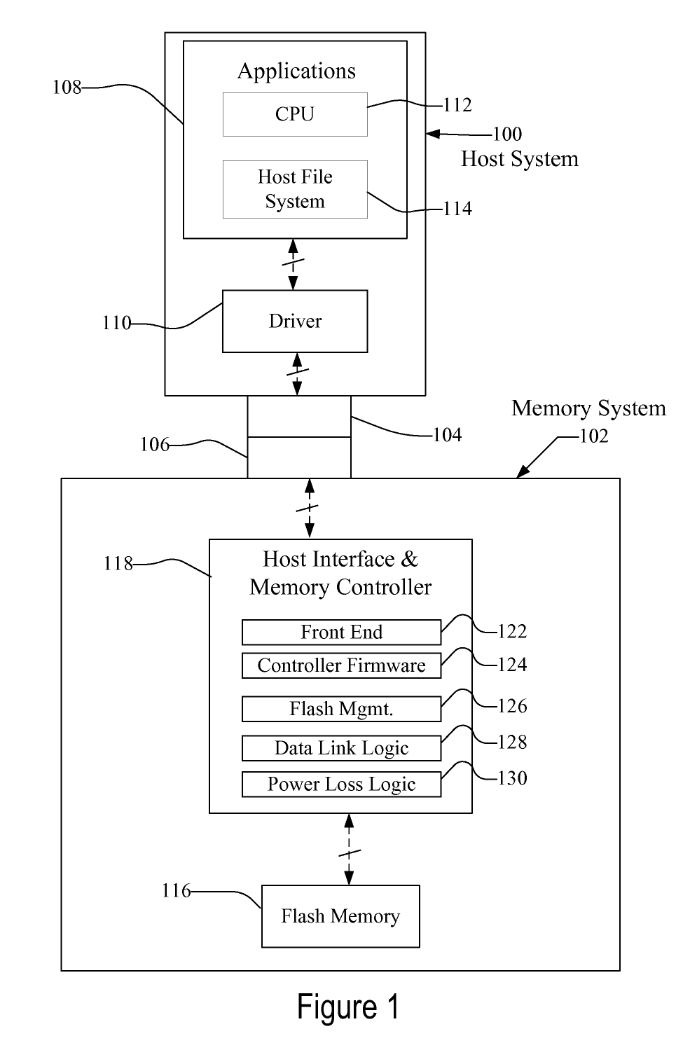

A flash memory system suitable for use in implementing aspects of the invention is shown in FIGS. 1-3. A host system 100 of FIG. 1 stores data into and retrieves data from a flash memory 102. The flash memory may be embedded within the host, such as in the form of a solid state disk (SSD) drive installed in a personal computer. Alternatively, the memory 102 may be in the form of a flash memory card that is removably connected to the host through mating parts 104 and 106 of a mechanical and electrical connector as illustrated in FIG. 1. A flash memory configured for use as an internal or embedded SSD drive may look similar to the schematic of FIG. 1, with one difference being the location of the memory system 102 internal to the host. SSD drives may be in the form of discrete modules that are drop-in replacements for rotating magnetic disk drives.

Examples of commercially available removable flash memory cards include the CompactFlash (CF), the MultiMediaCard (MMC), Secure Digital (SD), miniSD, Memory Stick, SmartMedia, TransFlash, and microSD cards. Although each of these cards may have a unique mechanical and/or electrical interface according to its standardized specifications, the flash memory system included in each may be similar. These cards are all available from SanDisk Corporation, assignee of the present application. SanDisk also provides a line of flash drives under its Cruzer trademark, which are hand held memory systems in small packages that have a Universal Serial Bus (USB) plug for connecting with a host by plugging into the host's USB receptacle. Each of these memory cards and flash drives includes controllers that interface with the host and control operation of the flash memory within them.

Host systems that may use SSDs, memory cards and flash drives are many and varied. They include personal computers (PCs), such as desktop or laptop and other portable computers, tablet computers, cellular telephones, smartphones, personal digital assistants (PDAs), digital still cameras, digital movie cameras, and portable media players. For portable memory card applications, a host may include a built-in receptacle for one or more types of memory cards or flash drives, or a host may require adapters into which a memory card is plugged. The memory system may include its own memory controller and drivers but there may also be some memory-only systems that are instead controlled by software executed by the host to which the memory is connected. In some memory systems containing the controller, especially those embedded within a host, the memory, controller and drivers are often formed on a single integrated circuit chip.

The host system 100 of FIG. 1 may be viewed as having two major parts, insofar as the memory 102 is concerned, made up of a combination of circuitry and software. They are an applications portion 108 and a driver portion 110 that interfaces with the memory 102. There may be a central processing unit (CPU) 112 implemented in circuitry and a host file system 114 implemented in hardware. In a PC, for example, the applications portion 108 may include a processor 112 running word processing, graphics, control or other popular application software. In a camera, cellular telephone or other host system 114 that is primarily dedicated to performing a single set of functions, the applications portion 108 includes the software that operates the camera to take and store pictures, the cellular telephone to make and receive calls, and the like.

The memory system 102 of FIG. 1 may include non-volatile memory, such as flash memory 116, and a system controller 118 that both interfaces with the host 100 to which the memory system 102 is connected for passing data back and forth and controls the memory 116. The system controller 118 may translate logical addresses of data used by the host 100 and physical addresses of the flash memory 116 during data programming and reading. Functionally, the system controller 118 may include a front end 122 that interfaces with the host system, controller logic 124 for coordinating operation of the memory 116, and flash management logic 126 for internal memory management operations. There may also be one or more flash interface modules (FIMs) to provide a communication interface between the controller with the flash memory 116.

The system controller 118 may also include data link logic 128. In one embodiment, the data link logic may be part of any of the front end 122, the controller logic/firmware 124, or the flash management logic 126. In an alternative embodiment, the data link logic 128 may be part of a separate circuit. The data link logic 128 may receive a signal indicating whether the host system 100 is connected with the memory system 102. In particular, the signal may be referred to as a data link signal and is indicative of whether there is a data link between the host system 100 and the memory system 102 through the mating parts 104 and 106. The loss of the data connection or data link may also be referred to as front end link loss. In one embodiment, the data link logic may include a drive ready state (e.g. DR_READY) and when there is an error or unexpected condition, such as a power down, the drive may be in an error state (e.g. DR_ERROR). In one embodiment, the Serial ATA Revision 3.0 (Gold Revision), dated Jun. 2, 2009 (e.g. pp. 327-328, the disclosure of which is hereby incorporated by reference), describes exemplary drive states that utilize the data link logic for transmitting a data link loss signal.

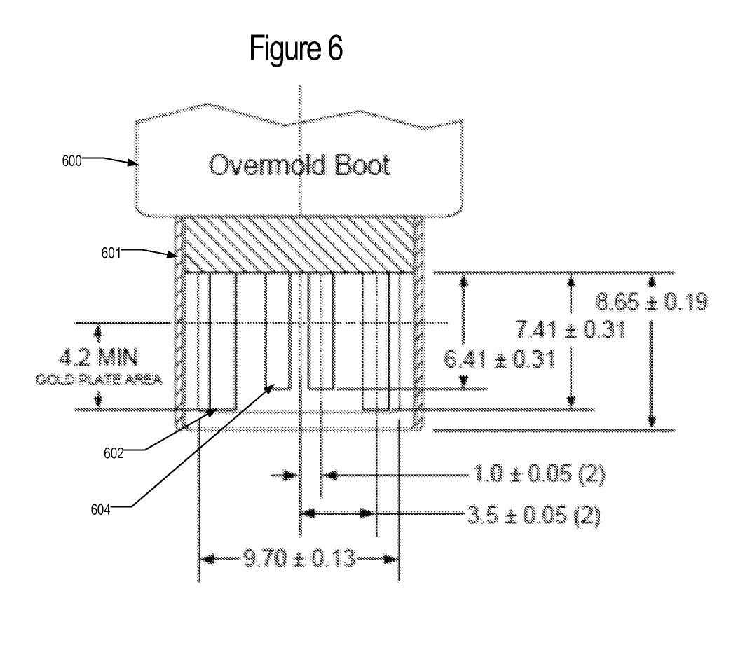

FIG. 6 illustrates the mating parts 104 and 106 that form the physical connection that results in the data link (prongs 604 in FIG. 6) and/or power link (prongs 602 in FIG. 6). The memory system 102 may include logic that is used for recovering the data connection/link) that may be part of or the same as the data link logic 128. Accordingly, the data link logic 128 may both monitor and maintain the data connection and data transfers with the host 100. As described, the data link may be between components within the host system 100 (e.g. applications 108) and components within the memory system 102 (e.g. front end 122).

The system controller 118 may also include power loss logic 130. In one embodiment, the power loss logic 130 may be a part of any of the front end 122, the controller logic/firmware 124, or the flash management logic 126. In alternative embodiments, the power loss logic 130 may be additional circuitry that is connected to the system controller 118. The power loss logic 130 may be part of or coupled with the data link logic 128. In particular, the power loss logic 130 may include instructions that communicate with the data link logic 128 to receive a data link loss signal from the data link logic 128. The power loss logic 130 may then transmit a power loss alert signal to the system controller 118 (e.g. the front end 122, the controller firmware 124 or the flash management 126), which is used to initiate emergency activities. Emergency activities may be referred to as data protection mechanisms and may include activities a storage device would perform upon power failure prediction such as storing critical information into non-volatile memory (e.g. NAND) or flushing host data into the NAND. Write abort protection is merely one example of an emergency activity that can be performed based on this power failure prediction. For simplicity, the description below describes write abort protection as an exemplary embodiment of an emergency activity that can be performed based on this power loss prediction.

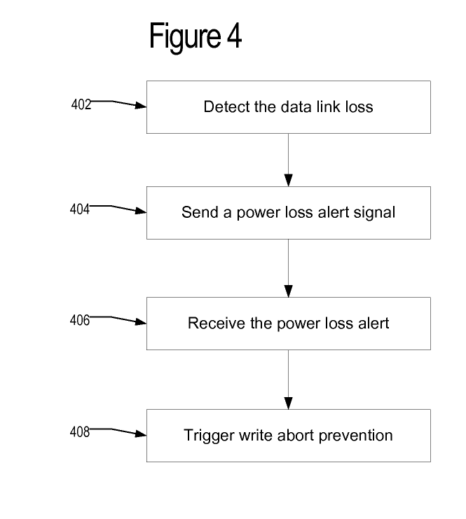

Write abort protection may include stopping future write operations and is further described with respect to FIG. 4. In one embodiment, the Serial ATA Revision 3.0 (Gold Revision), dated Jun. 2, 2009 (e.g. pp. 185-186, the disclosure of which is hereby incorporated by reference), describes a SATA front end with a PHYRDY signal that indicates that a host device is functioning properly. When the PHYRDY signal is negated or absent it indicates a link loss.

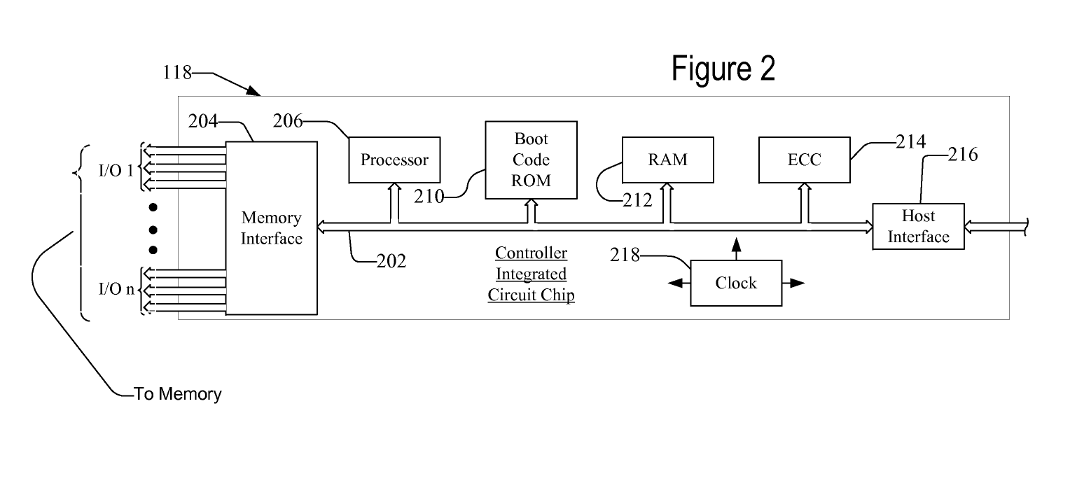

The system controller 118 may be implemented on a single integrated circuit chip, such as an application specific integrated circuit (ASIC) such as shown in FIG. 2. The processor 206 of the system controller 118 may be configured as a multi-thread processor capable of communicating via a memory interface 204 having I/O ports for each memory bank in the flash memory 116. The system controller 118 may include an internal clock 218. The processor 206 communicates with an error correction code (ECC) module 214, a RAM buffer 212, a host interface 216, and boot code ROM 210 via an internal data bus 202. The ROM 210 may be used to initialize a memory system 102, such as a flash memory device. The memory system 102 that is initialized may be referred to as a card. The host interface 216 may provide the data connection with the host, such that a disconnect of that data connection results in a data link loss signal that initiates write abort protection. The disconnection may be a physical disconnect or a logical disconnect. The processor 206 may receive the data link loss signal from the host interface 216 and may terminate write operations from the memory interface 204 as part of the write abort protection.

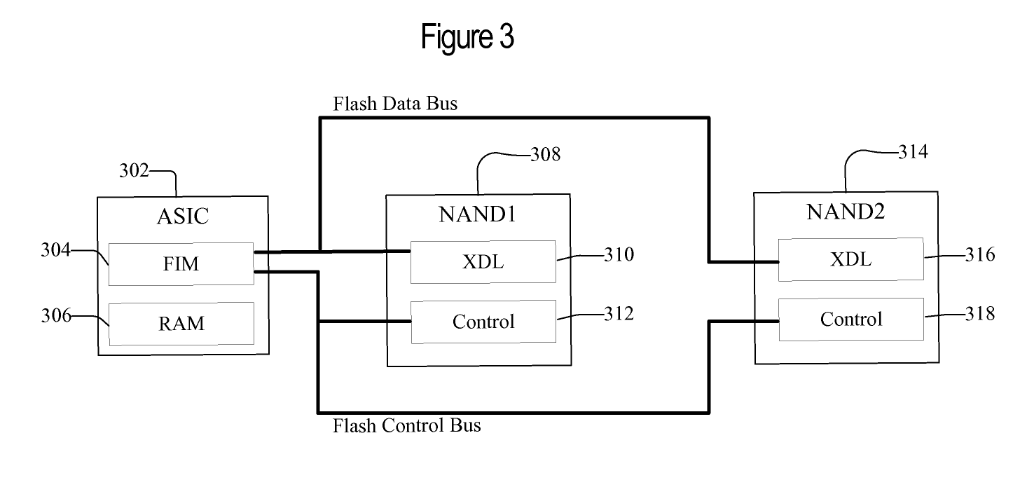

FIG. 3 is a block diagram of an alternative memory communication system. An application-specific integrated circuit (ASIC) 302 may include a flash interface module (FIM) 304 and random access memory (RAM) 306. The ASIC 302 may be a chip that communicates with multiple flash memory modules or devices, such as NANDs 308, 314. The FIM 304 communicates data over the flash data bus and communicates control commands over the flash control bus. The NAND1 308 and NAND2 314 are types of flash memory that receive commands and data from the FIM 304 of the ASIC 302. Each of the NAND1 308 and NAND2 314 include controls 312, 318, respectively, for receiving control signals from the ASIC 302. Likewise, each of the NAND1 308 and NAND2 314 include an eXternal Data Latch (XDL) 310, 316, respectively, for receiving data signals from the ASIC 302. Although the flash data bus and flash control bus are illustrated as separate busses that communicate with the XDL 310, 316 and Control 312, 318 of the respective NANDs 308, 314, there may be a singular bus for communication. As described, a data link loss detected at the FIM 304 indicating a loss of the data connection with the host may be used for triggering write abort protection. There may be stop write command from the FIM 304 such that the write operations or read operations over the flash data bus to the NAND1 308 and the NAND2 314 are terminated to prevent a potential write abort.

The NANDs of FIG. 3 and/or the flash memory of FIG. 1 may include memory cells operated to store two levels of charge so that a single bit of data is stored in each cell. This is typically referred to as a binary or single level cell (SLC) memory. Alternatively, the memory cells may be operated to store more than two detectable levels of charge in each charge storage element or region, thereby to store more than one bit of data in each. This latter configuration is referred to as multi-level cell (MLC) memory. Both types of memory cells may be used in a memory, for example binary flash memory may be used for caching data and MLC memory may be used for longer term storage. The charge storage elements of the memory cells are most commonly conductive floating gates but may alternatively be non-conductive dielectric charge trapping material. In implementations of MLC memory operated to store two bits of data in each memory cell, each memory cell is configured to store four levels of charge corresponding to values of “11,” “01,” “10,” and “00.” Each bit of the two bits of data may represent a page bit of a lower page or a page bit of an upper page, where the lower page and upper page span across a series of memory cells sharing a common word line. Typically, the less significant bit of the two bits of data represents a page bit of a lower page and the more significant bit of the two bits of data represents a page bit of an upper page.

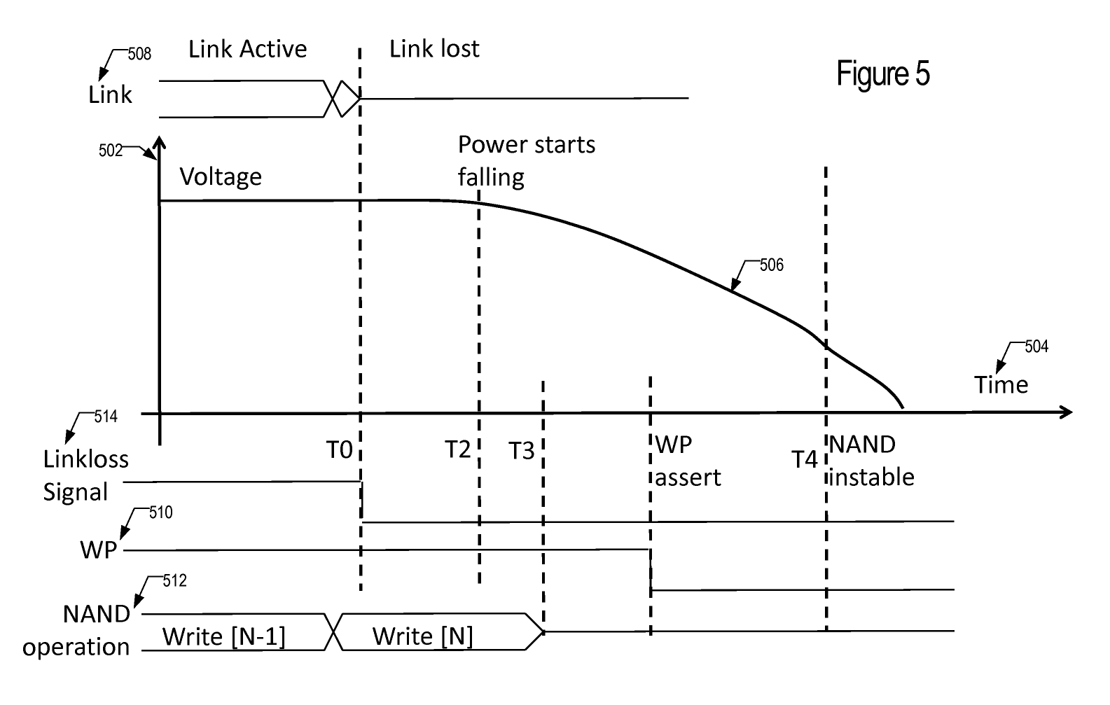

FIG. 4 is a diagram of a process for write abort prevention. In particular, the write abort prevention is based on predicting and identifying a power loss. In block 402, a data link loss is detected. The data link loss is an indication that there may be a power loss. As discussed above, the data link logic 128 may identify when the data connection with the host has been lost. The data link loss triggers a power loss alert signal in block 404. The power loss alert signal may originate from the power loss logic 130. The power loss alert signal may be provide to the memory controller as in block 406. The power loss alert signal may also trigger a write protect (WP) signal assertion. The memory controller can trigger write abort prevention in block 408. The write abort prevention may include stopping future writes as described below with respect to FIG. 5.

Utilizing the data link lost signal as a trigger for identifying an upcoming power loss may provide additional time for write abort prevention as opposed to the actual detection of the power loss. Other systems may monitor the power rail voltage such that when it is below a threshold, there is an event triggered (e.g. write abort protection). The threshold is typically above a power fail threshold level, which is a value below which the memory card cannot operate. If the time duration between the power fail detection until a fatal power level is long enough to accommodate the ongoing NAND or memory write operation to complete, then write abort may be prevented. Accordingly, since the data link disconnect may be identified sooner than the power supply drop, the chances of a write abort are decreased. Exemplary reasons why the data disconnect may be recognized before the power drop are discussed with respect to FIG. 6.

Write abort protection may include completing existing NAND/memory writes, while preventing future NAND/memory writes. Since a write abort occurs when a write is not completed (which may result in data loss and/or corruption), write abort protection requires a prompt identification of a state (e.g. power loss) in which the write cannot be completed. Write abort protection may include preventing the issuance of any further commands to the NAND/memory from the controller.

FIG. 5 is an illustration of write abort prevention. The timing of events shown in FIG. 5 is merely exemplary and illustrates how the write abort protection mechanism is triggered from the loss of the data connection with a data link loss signal. Further, the timing illustrated in FIG. 5 may depend on the system energy consumption and the host capacitance available to maintain this energy. A diagram of the voltage 502 on the y-axis versus the time 504 on the x-axis illustrates a voltage level 506 that reflects the power supply of the device. There are four time periods (T0, T2, T3, T4) illustrated along the x-axis of time 504. At time T0, the data link 508 is lost. As described, the data connection is terminated and a data link loss signal (“Linkloss”) 514 is received. Once that signal 514 is received, the write abort protection mechanism triggered at time T0. In particular, the Linkloss signal 514 notifies the controller that a pending power loss may occur and a write protect signal 510 is asserted. The write protect signal 510 may be used to control the NAND operation 512 of the controller. In particular, the NAND operation 512 in FIG. 5 illustrates different write commands (write command N−1 and write command N).

Upon assertion of the Linkloss signal 514 future write operations are stopped after the write protect 510 signal is asserted. In other words, there is no N+1 write commands because the Linkloss signal 514 indicates the pending power loss. In the voltage level 506, the NAND will fail at time T4. Time T4 represents the point at which the NAND does not have sufficient power supply to operate. If there were a write operation occurring during time T4, that operation would fail and result in a write abort. Writes that are initiated before the Linkloss signal 514 are completed and future write commands are refused.

There may be a grace period in FIG. 5 from the time the Linkloss signal 514 is asserted at time T0 until the NAND fails at time T4 before pending write operations can complete. The earlier the Linkloss and consequently the write abort signal is asserted, the greater the grace period is, which reduces the chances of a write abort error. Accordingly, the detection of a potential power loss should be identified or predicted as soon as possible. As described, that detection is triggered from a loss of the data connection with the host rather than a loss of the power level shown as T2 in FIG. 5. In other words, the triggering of the write abort protection procedure is based on the data link lost rather than on the voltage level 506 provided to the device. At time T0, before there is any drop in voltage level 506, the device can begin write abort protection. The write protect signal 510 may be asserted once NAND operation [N] has completed for further protection against write abort.

FIG. 6 is a diagram of one possible connector arrangement which illustrates how the triggering of the Linkloss signal 514 based on the loss of the data connection may precede the change in the voltage level 506 that is discussed above. FIG. 6 illustrates an exemplary universal serial bus (USB) connector 601 that is the connecting portion of the memory system. There may be a boot portion 600 and a connector portion 601 as shown in FIG. 6. The connector portion 601 may include a number of fingers or prongs 602, 604. In particular, there are four prongs illustrated in FIG. 6. The outside prongs 602 provide power to the memory device, while the inside prongs 604 provide data to the memory device. When the USB device is removed from a host connection, the data prongs 604 lose connection from the host before the power prongs 602 because the power prongs 602 are longer and maintain contact for a short time longer. In other words, the shorter data prongs 604 lose connection before the longer power prongs 604. Since the data connection is lost before the power connection is lost, triggering the write abort protection procedure from the data connection loss or Linkloss signal is quicker than triggering it from the power connection loss. Although the time difference caused by the length of the prongs may only be milliseconds, that time savings may prevent a write abort.

USB devices with connectors as described above are merely one example of a type of memory device that benefits from power loss prediction based on data link loss. Due to the small dimensions of a USB flash drive there may be no printed circuit board real estate available for large capacitors to store enough energy to allow voltage drop detection followed by write abort protection procedure. Further, due to the low cost requirement of a USB flash drive there may be no justification for including costly capacitors. Finally, due to USB standard limitations the maximum amount of capacitance allowed on USB flash drive power rail (VBUS) is 10 uF. Accordingly, USB flash drives benefit from the additional period provided by triggering write abort mechanism on the data link loss. Other connectors in which the data connection is lost before the power connection include Compact Flash (CFAST) or Serial AT Attachment (SATA). Alternatively, in some devices, the data connection may not be lost before the power is lost which may eliminate the advantage (e.g. an extended grace period in FIG. 5) of the embodiments described herein.

As used herein, “computer-readable medium,” “machine readable medium,” “propagated-signal” medium, and/or “signal-bearing medium” may comprise any device that includes, stores, communicates, propagates, or transports software for use by or in connection with an instruction executable system, apparatus, or device to carry out steps such as those described above. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a processor, memory device, computer and/or machine memory.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

We claim:

1. A flash memory device comprising:
a non-volatile storage having an array of memory blocks storing data; and
a controller in communication with the non-volatile storage, wherein the controller is configured to:
detect a data link loss with a host; and
trigger an emergency activity upon detection of the data link loss that is independent of a power loss detection.

2. The device of claim 1 wherein the emergency activity includes at least one of write abort protection, storing critical information into the non-volatile storage, or flushing host data into the non-volatile storage.

3. The device of claim 2 wherein for the write abort protection, the controller is further configured to:
transmit a write protect signal upon the detection of the data link loss.

4. The device of claim 2 wherein for the write abort protection, the controller is further configured to:
stop upcoming write operations to the memory blocks.

5. The device of claim 2 wherein the power loss detection is based on monitoring voltage levels.

6. The device of claim 5 wherein the write abort protection is triggered without monitoring the voltage levels of the device.

7. The device of claim 1 wherein the data link loss detection occurs before a host power loss detection and the data link loss detection is based on a disconnection of the device from the host that results in the disconnection of the data connection before the host power is lost.

8. The device of claim 1 wherein the device comprises a Universal Serial Bus (“USB”) memory device in which data prongs are shorter than power prongs such that the data prongs lose data connection before the power prongs lose power connection upon removal of the USB from a host.

9. The device of claim 8 wherein the data link loss detection comprises a lost connection of the data prongs from the host.

10. A method for predicting power loss in a flash memory device comprising:
in a non-volatile storage device having a controller and blocks of memory, the controller:
issues a plurality of requests for write operations to write data to the blocks of memory;
receives an indication of a data link loss;
completes a current one of the write operations; and
stops, upon receipt of the indication of the data link loss, future write operations.

11. The method of claim 10 wherein the indication of the data link loss indicates a potential pending power loss.

12. The method of claim 10 wherein the write abort protection is triggered without monitoring voltage levels of the device.

13. The method of claim 10 wherein the data link loss indicates a disconnection of the flash memory device from a host.

14. The method of claim 13 wherein the data link loss detection occurs before power is lost from the host as a result of the host being disconnected from the flash memory.

15. The method of claim 13 wherein the flash memory includes a Universal Serial Bus (“USB”) connector in which data prongs are shorter than power prongs such that the data prongs lose data connection before the power prongs upon removal of the USB from a host.

16. The method of claim 15 wherein the data link loss detection comprises a lost connection of the data prongs from the host.

17. A memory system comprising:
a non-volatile storage having an array of memory blocks storing data; and
a controller in communication with the blocks, the controller configured to:
identify a termination of a data link with a host before identifying a change in voltage; and
prevent additional write operations in response to the termination of the data link.

18. The memory system of claim 17 wherein the termination of the data link occurs before a power loss results in the change in voltage.

19. The memory system of claim 17 wherein the preventing of additional write operations protects against a write abort in which write operations are not completed before power is lost at the memory system.

20. The memory system of claim 17 wherein the memory system includes a Universal Serial Bus (“USB”) connector in which data prongs are shorter than power prongs such that the data prongs lose data connection before the power prongs lose a power connection upon removal of the USB from a host, further wherein the termination of the data link is identified because of the lost connection of the data prongs with the host.
